(19) United States
(12) Patent Application Publication
(10) Pub. No.: US 2026/0145254 A1
(43) Pub. Date: May 28, 2026

(54) HONING RING FOR SURFACE FINISHING OF A TOOTHED WORKPIECE

(71) Applicant: Tyrolit-Schleifmittelwerke Swarovski AG & Co K.G., Schwaz (AT)

(72) Inventor: Bernd HEINRICH, Neuenrade (DE)

(21) Appl. No.: 19/400,525

(22) Filed: Nov. 25, 2025

(30) Foreign Application Priority Data
Nov. 26, 2024 (AT) A 50928/2024

(51) Int. Cl. B23F 21/03; B23F 19/05

(52) U.S. Cl. CPC B23F 21/03; B23F 19/057

(57) ABSTRACT

A honing ring for surface finishing a toothed workpiece, preferably a gear, includes at least one base ring and at least one abrasive. A toothing is arranged on an inner cylindrical surface of the at least one base ring, and the toothing of the at least one base ring is at least partially, and preferably completely, coated with the at least one abrasive, preferably galvanically. The toothing can be brought into contact with the toothed workpiece, and the base ring comprises or consists at least partially of at least one metal, preferably at least two or at least three or more metals.

### DESCRIPTION

### BACKGROUND OF THE INVENTION

The present invention relates to a honing ring for surface finishing of a toothed workpiece, preferably a gear, comprising a base ring and an abrasive. Furthermore, the invention relates to an arrangement with such a honing ring, a method for manufacturing such a honing ring and a method for surface treatment of workpieces with such a honing ring.

Honing and honing rings are known, for example, from AT 524577 A4 and AT 522706 A1. Honing is a machining process that involves finishing the surface of workpieces. A honing ring can be used for surface finishing of toothed workpieces such as gears. Such honing rings have a ceramic base body in which an abrasive is embedded.

A disadvantage of prior art honing rings is that they are subject to high wear.

### SUMMARY OF THE INVENTION

The object of the present invention is therefore to at least partially eliminate the disadvantages of the prior art and to provide an improved honing ring in comparison with the prior art, which is distinguished in particular by less wear.

The object is also to specify an arrangement with such an improved honing ring, a method for manufacturing such an improved honing ring and a method for surface finishing of toothed workpieces with such an improved honing ring.

This object is achieved by means of a honing tool with a honing ring for surface finishing of a toothed workpiece, preferably a gear, comprising at least one base ring and at least one abrasive. A toothing is arranged on an inner cylindrical surface of the at least one base ring, and the toothing of the at least one base ring is covered at least partially, preferably completely, with the at least one abrasive, preferably galvanically, and can be brought into contact with the toothed workpiece. Furthermore, the at least one base ring comprises or consists at least in regions of at least one metal, preferably at least two or at least three or more metals.

Because at least one base ring has or consists of at least one metal, the toothing of the at least one base body can be electrochemically processed and/or galvanically coated with the at least one abrasive. For example, in contrast to a ceramic base body with embedded abrasive, a metallic base body with galvanically applied abrasive exhibits higher resistance to wear.

The possibility of electrochemical processing and/or galvanic coating with abrasives can offer further advantages such as higher profile accuracy, longer durability and service life, higher machining performance and/or higher grinding efficiency.

Electrochemical processing can, for example, involve electrochemical material removal, particularly for deburring, electropolishing and/or producing the final gear geometry.

A galvanic coating can be described as an electrochemical deposition.

The phrase “the toothing of the at least one base ring is coated at least in regions, preferably completely, with the at least one abrasive, preferably galvanically” means that the toothing of the at least one base ring is provided with at least one, preferably galvanic, coating at least in regions, preferably completely, wherein the at least one coating comprises the at least one abrasive.

In one exemplary embodiment of the honing ring, the base ring is manufactured from metal powder by pressing and/or sintering. In this example, if the metal powder is mixed with abrasive before pressing and/or sintering, a base ring with abrasive distributed therein is produced. Accordingly, part of the abrasive is also located on the surface of the base ring and thus also on the surface of the toothing of the base ring, meaning that it is covered with abrasive at least in regions.

In another embodiment of the honing ring, the base ring including the toothing is manufactured and then at least a part of the toothing of the base ring is provided with a coating, wherein the coating comprises the abrasive. Such a coating can, for example, contain a bond and an abrasive. Well-known examples of bonds are ceramic bonds or resin bonds. In this way, a large proportion of abrasive material can be saved compared to the previous exemplary embodiment. In this example, the coating is not an inherent part of the base ring, but a separate part of the honing ring.

In another preferred exemplary embodiment of the honing ring, the base ring is manufactured with the toothing and then at least a part of the toothing of the base ring is provided with a coating, wherein the coating comprises the abrasive and is applied galvanically, i.e. electrochemically. Such a coating can, for example, contain a galvanic bond and the abrasive. Nickel, for example, can be used as a galvanic bond. In this way, compared to the previous exemplary embodiment with a non-galvanic bond, a higher profile accuracy, machining performance and/or grinding efficiency of the honing ring can be achieved. In this example, the coating is not an inherent part of the base ring, but a separate part of the honing ring.

It should be explicitly noted here that a coating applied only to the outer surface of the base ring is not part of the base ring. If, as in the above exemplary embodiment, metal powder is mixed with abrasive and the base ring is then produced, the base ring has a metal and an abrasive and at the same time the base ring is coated with an abrasive. In this case, the abrasive is an inherent part of the base ring. In the two other exemplary embodiments above, the base ring does not have an abrasive, but is only coated with the abrasive on its surface. The coating comprising the abrasive is no inherent part of the base ring.

In a preferred exemplary embodiment of the honing ring, the mass fraction of at least one metal or at least two metals or at least three metals or multiple metals or all metals present in the base ring is between 90% and 100%, preferably between 95% and 100%, particularly preferably between 99% and 100%.

A base ring made of at least one, at least two, at least three or more metals may contain minor, sometimes non-metallic, impurities.

A person skilled in the art understands “a base ring consisting of at least one metal” or, in other words, “a base ring made of at least one metal” to mean that the base ring is composed of the at least one metal, apart from minor impurities.

For the sake of completeness, it should be noted that in the course of describing this disclosure, the numerical terms used, such as one, two, three and the like, basically only describe the minimum quantity of a feature of the disclosed honing ring. Individual features or components can of course also be present in larger quantities. For example, the disclosed honing rings can have more than one metal, more than one mounting ring, etc. In this sense, for example, the numeral “one” is to be understood as meaning at least one, etc.

According to a preferred embodiment of the honing ring, the at least one metal is a non-ferrous metal.

In a preferred exemplary embodiment, the at least one metal is a non-ferrous metal.

According to a preferred embodiment of the honing ring, the at least one metal has an electrical conductivity greater than 1.00·10⁷ S/m, preferably greater than 1.30·10⁷ S/m, particularly preferably greater than 3.00·10⁷ S/m.

In a preferred exemplary embodiment of the honing ring, the electrical conductivity of the at least one metal is between 1.00·10⁷ S/m and 10.00·10⁷ S/m, preferably between 3.00·10⁷ S/m and 7.00·10⁷ S/m, particularly preferably between 5.00·10⁷ S/m and 6.50·10⁷ S/m.

Below are some electrical conductivity values of metals:
6.1·10⁷ S/m Silver
5.8·10⁷ S/m Copper
3.7·10⁷ S/m Aluminum
1.0·10⁷ S/m Iron
0.9·10⁷ S/m Steel C35

Higher electrical conductivity allows for more precise, simpler and/or more controllable galvanic coating. Thus, the bond between the base ring and the abrasive, its strength and/or its wear resistance is adjustable and/or higher compared to known honing rings.

According to a preferred embodiment of the honing ring, the at least one metal is aluminum, copper, zinc or tin and/or the at least one base ring comprises or consists of at least one alloy, wherein the at least one alloy is bronze, in particular aluminum bronze, or brass.

One advantage of copper is its high electrical conductivity, which has a positive effect on galvanic coating, especially when it comes to galvanic coating with diamonds.

Another advantage of copper is that it is a softer metal, for example compared to other metals or alloys such as steel. Thus, a copper base ring creates a damping effect, which has a positive impact on the machinability and use of the honing ring. For example, this makes it easier to introduce a pre-toothing into the base ring.

In a preferred exemplary embodiment of the honing ring, in the case of at least one base ring comprising or consisting of at least two metals, at least three metals or more metals, at least one, at least two, at least three, several or all of the metals present in the at least one base ring:
are a non-ferrous metal, and/or
have an electrical conductivity greater than 1.00·107 S/m, preferably greater than 1.30·10⁷ S/m, particularly preferably greater than 3.00·10⁷ S/m, and/or
are aluminum, copper, zinc or tin, and/or
are an alloy of bronze, in particular aluminum bronze, or brass.

In a preferred exemplary embodiment of the honing ring, the at least one base ring has a density between 2.0 g/cm 3 and 10.0 g/cm 3 , preferably between 2.7 g/cm 3 and 8.6 g/cm 3.

According to a preferred embodiment of the honing ring, the at least one abrasive has or consists of abrasive grains, preferably wherein the abrasive grains have a grain size between 0.035 mm and 0.181 mm, particularly preferably between 0.039 mm and 0.091 mm, most preferably of 0.054 mm, and/or between 57 mesh and 500 mesh, particularly preferably between 80 mesh and 400 mesh, most preferably between 100 mesh and 139 mesh.

Abrasive grains with the aforementioned grain sizes offer advantages in terms of the bond strength of the galvanic coating and/or wear resistance.

The grain size can be specified in mm.

Grain size can be specified in the unit of measurement mesh, which indicates the number of meshes in a net per inch, i.e. 25.4 mm. The higher the mesh number, the finer the grain.

According to a preferred embodiment of the honing ring, the at least one abrasive has or consists of diamond and/or boron nitride, preferably cubic boron nitride, abbreviated CBN.

A honing ring galvanically coated with diamond and/or CBN experiences less wear or no wear at all compared to a ceramic honing ring, thus eliminating the need to dress the honing ring after a certain number of honing operations.

The dressing process interrupts the honing operation. Therefore, higher quantities can be honed per unit of time using a diamond and/or CBN galvanically coated honing ring. This leads to time savings and/or cost savings.

Another advantage of a honing ring galvanically coated with a diamond and/or CBN is a higher profile accuracy compared to a ceramic honing ring.

According to a preferred embodiment of the honing ring, the at least one base ring is surrounded in the radial direction by at least one mounting ring, wherein the at least one mounting ring comprises or consists of at least one synthetic resin.

One advantage of the at least one mounting ring is a substantially constant cutting force during the honing process, the absorption of forces and the damping effect in the honing process, especially the damping of force peaks, which reduces tool breakage, extends the service life of the honing ring and improves the grinding result.

In this context, the term “grinding result” can also be understood, by analogy, as a honing result of the honing ring in a manufacturing process with a geometrically undefined cutting edge.

By combining the different damping effects of a copper-containing base ring or a base ring consisting of copper and a mounting ring, a synergistic damping effect can be achieved.

In a preferred exemplary embodiment, the at least one synthetic resin has at least one of the following material properties before curing:
a dynamic viscosity at 25° C. between 55 mPas and 85 mPas, preferably 70 mPas,
a density at 20° C. between 1.00 g/cm³ and 1.10 g/cm³, preferably 1.05 g/cm³,
a pot life of 200 g and 20° C. between 2.0 min and 4.0 min, preferably between 2.5 min and 3.5 min, and
a demolding time at room temperature, preferably at 20° C., between 0.25 h and 1.5 h, preferably between 0.5 h and 1 h.

In a preferred exemplary embodiment, the at least one synthetic resin has at least one of the following material properties after curing:
a flexural strength according to EN ISO 178 between 35 MPa and 55 MPa, preferably 45 MPa,
a bending elongation at fracture according to EN ISO 178 between 6.0% and 7%, preferably 6.4%,
a modulus of elasticity and/or a bending modulus according to EN ISO 178 between 1200 MPa and 1500 MPa, preferably 1350 MPa,
an impact strength according to Charpy as per EN ISO 179 between 10 kJ/m² and 20 kJ/m², preferably 15 MPa,
a compressive strength according to EN ISO 604 MPa between 25 MPa and 45 MPa, preferably 35 MPa, and
a Shore hardness according to DIN ISO 7619-1 of Shore D.

According to a preferred embodiment of the honing ring, the at least one synthetic resin has or consists of a polyurethane.

According to a preferred embodiment of the honing ring, the at least one synthetic resin is a 2-component synthetic resin.

According to a preferred embodiment of the honing ring, the at least one synthetic resin has or consists of at least one resin and at least one hardener.

In a preferred exemplary embodiment, the at least one synthetic resin has a mass ratio between the at least one resin and the at least one hardener of 0.1 to 10, preferably 1.

In a preferred exemplary embodiment, the at least one resin has at least one of the following material properties:
a dynamic viscosity at 25° C. between 130 mPas and 200 mPas, preferably 165 mPas, and
a density at 20° C. between 0.90 g/cm³ and 1.10 g/cm³, preferably 1.00 g/cm³.

In a preferred exemplary embodiment, the at least one resin comprises or consist of a naphthalene and/or a polyol, preferably bisisopropylnaphthalene CAS 38640-62-9 and/or alkylaminopolyoxyalkylenol CAS 25214-63-5.

In a preferred exemplary embodiment, the at least one hardener has at least one of the following material properties:
a viscosity at 25° C. between 50 mPas and 70 mPas, preferably 60 mPas,
a density at 20° C. between 1.00 g/cm³ and 1.20 g/cm 3, preferably 1.10 g/cm³.

In a preferred exemplary embodiment, the at least one hardener may comprise or consist of naphthalene and/or an isocyanate.

In a preferred exemplary embodiment, the at least one hardener may comprise or consist at least of:
bisisopropylnaphthalene CAS 38640-62-9 with a mass fraction in the hardener between 25% and 50%,
diphenylmethane diisocyanate CAS 9016-87-9 with a mass fraction in the hardener between 25% and 50%,
4,4′-methylenediphenyl diisocyanate CAS 101-68-8 with a mass fraction in the hardener between 10% and 25%,
o-p-isocyanatobenzylphenyl isocyanate CAS 5873-54-1 with a mass fraction in the hardener between 2.5% and 5%, preferably 2.5% and 4.9%, and/or
2,2′-methylenediphenyl diisocyanate CAS 2536-05-2 with a mass fraction in the hardener of less than 0.1%.

According to a preferred embodiment of the honing ring, the at least one synthetic resin has fillers, preferably wherein the mass fraction of the fillers in the synthetic resin is between 5% and 65%, particularly preferably between 10% and 50%.

The properties of the at least one mounting ring can be influenced by fillers. For example, the damping behavior, strength, service life and/or other properties of the mounting ring and/or the honing ring can be thus adjusted.

In a preferred exemplary embodiment, the fillers comprise or consist of aluminum hydroxide, preferably wherein the mass fraction of aluminum hydroxide in the fillers is between 50% and 100% and/or the density of the aluminum hydroxide is between 600 kg/m³ and 2500 kg/m³, particularly preferably 2420 kg/m³.

Furthermore, protection is sought for an arrangement comprising a honing ring disclosed herein for surface finishing of a toothed workpiece, preferably a gear, and for the toothed workpiece and optionally for a honing machine for clamping the honing ring.

Furthermore, protection is sought for a method for manufacturing a honing ring disclosed herein for surface finishing a toothed workpiece, preferably a gear, or an arrangement disclosed herein, wherein the honing ring comprises at least one base ring and at least one abrasive. A toothing is arranged on an inner cylindrical surface of the at least one base ring, and the toothing of the at least one base ring is coated, at least in areas, preferably completely, with the at least one abrasive, preferably electroplated, and can be brought into contact with the toothed workpiece. The at least one base ring is made with or from at least one metal, preferably with or from at least two or at least three or more metals.

According to a preferred embodiment of the method, at least one of the following, preferably chronological, method steps is provided:
providing the at least one base ring, wherein the at least one base ring comprises or consists of at least one metal, preferably at least two or at least three or more metals, wherein a toothing is arranged on an inner cylindrical surface of the at least one base ring and can be brought into contact with the toothed workpiece,
providing the at least one abrasive,
coating, preferably galvanic coating, the toothing of the at least one base ring with the at least one abrasive.

According to a preferred embodiment of the method, it may be provided that the provision of the at least one base ring comprises at least one, preferably two, three, four or more of the following, preferably chronological, method steps:
pressing, preferably hot pressing and/or cold welding, of at least one base ring made of metal powder,
sintering of the at least one base ring made of metal powder,
machining of the at least one base ring from solid metal material,
machining, preferably turning of the outer diameter, the inner diameter and/or at least one of the two end faces, of the at least one base ring,
providing a pre-toothing on the at least one base ring, preferably using a profile grinding wheel, and
dressing the at least one base ring, preferably with a dressing wheel, in particular preferably with diamond coating.

The use of a metal powder can bring various advantages. For example, manufacturing a base ring from metal powder involves lower procurement effort, and in particular lower costs, than manufacturing molded parts from solid material. Furthermore, less waste is generated during the forming process compared to forming solid material, which offers economic, ecological and organizational advantages.

According to a preferred embodiment of the method, at least one of the following, preferably chronological, method steps may be provided:
providing at least one mounting ring, wherein the at least one mounting ring comprises or consists of at least one synthetic resin,
providing at least one support ring by connecting the at least one base ring with the at least one mounting ring, preferably wherein the at least one base ring is surrounded in a radial direction by the at least one mounting ring, and
coating, preferably galvanic coating, the at least one support ring, preferably the toothing of the at least one base ring of the at least one support ring with the at least one abrasive.

According to a preferred embodiment of the method, the provision of the at least one mounting ring and/or support ring may comprise at least one, two, three, or all of the following, preferably chronological, method steps:
arranging, preferably centering, the at least one base ring in a casting mold,
casting around the at least one base ring in a radial direction with a synthetic resin compound,
curing of the resin mass to form at least one mounting ring, and
machining, preferably turning of the outer diameter, the inner diameter and/or at least one of the two end faces, of the at least one mounting ring and/or of the at least one support ring.

According to a preferred embodiment of the method, the at least one metal and/or the metal powder and/or the solid metal material may comprise or consist of at least one dendritic metal, aluminum, copper, preferably dendritic copper, zinc, tin, bronze, preferably aluminum bronze, and/or brass.

Furthermore, protection is sought for a method for surface finishing of toothed workpieces with a honing ring disclosed herein or a method disclosed herein, comprising the following, preferably chronological, method steps:
clamping the honing ring in a honing machine,
processing a toothed workpiece, preferably a gear, particularly preferably a transmission gear, with the clamped honing ring in the honing machine.

### BRIEF DESCRIPTION OF THE DRAWINGS

Further details and advantages of the present invention will be provided in more detail hereinafter with reference to the drawings, in which:

FIG. 1: is a perspective view of an exemplary embodiment of a honing ring, and

FIG. 2: shows a schematic method sequence for manufacturing the honing ring from FIG. 1.

### DETAILED DESCRIPTION OF THE INVENTION

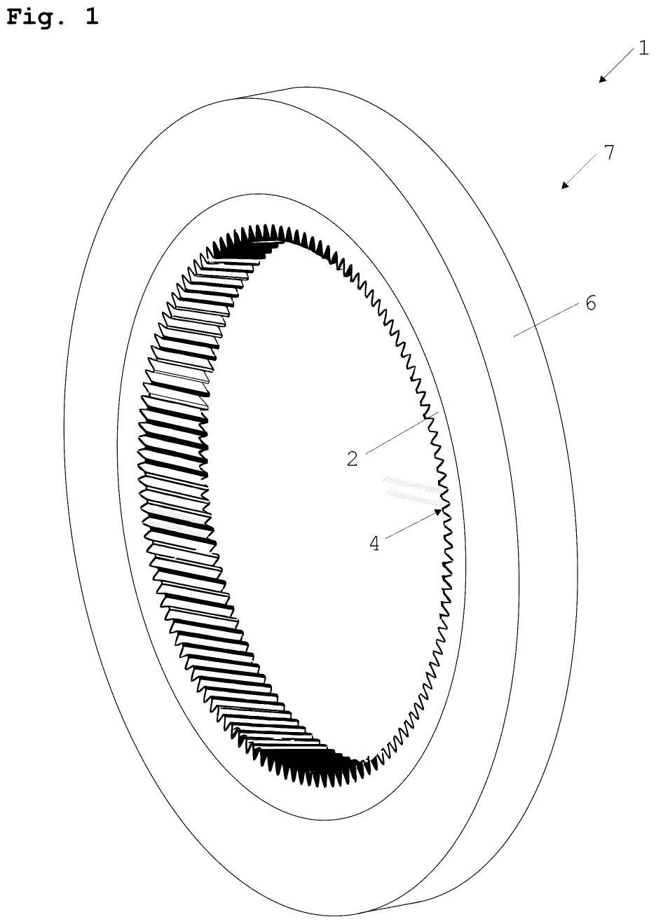

FIG. 1 shows a perspective view of an exemplary embodiment of a honing ring.

FIG. 1 shows a honing ring 1 for surface finishing a toothed workpiece, preferably a gear, comprising at least one base ring 2 and at least one abrasive 3, wherein a toothing 4 is arranged on an inner cylindrical surface 5 of the at least one base ring 2, wherein the toothing 4 of the at least one base ring 2 is coated at least in regions, preferably completely, with the at least one abrasive 3, preferably galvanically, and can be brought into contact with the toothed workpiece, wherein the at least one base ring 2 comprises or consists at least in regions of at least one metal, preferably at least two or at least three or more metals.

The coating with abrasive is not visible in FIG. 1.

The honing ring 1 in FIG. 1 has, apart from the base ring 2, a mounting ring 6. The base ring 2 and the mounting ring 7 together form a support ring 7.

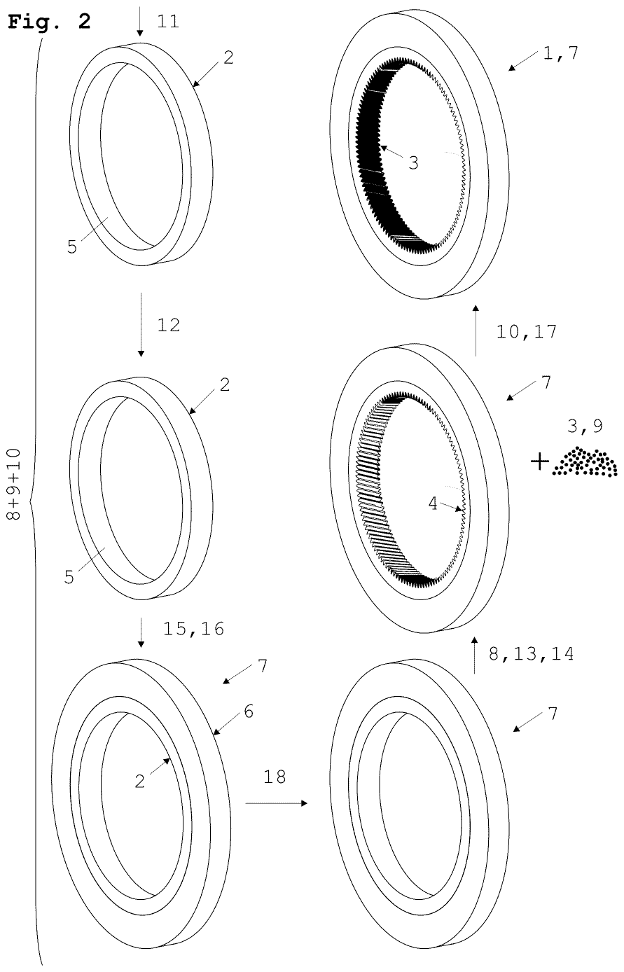

FIG. 2 shows a schematic method sequence for manufacturing the honing ring from FIG. 1.

FIG. 2 shows a method for manufacturing a honing ring 1 for surface finishing a toothed workpiece, preferably a gear, wherein the honing ring 1 has at least one base ring 2 and at least one abrasive 3, wherein a toothing 4 is arranged on an inner cylindrical surface 5 of the at least one base ring 2, wherein the toothing 4 of the at least one base ring 2 is coated, at least in regions, preferably completely, with the at least one abrasive 3, preferably galvanically, and can be brought into contact with the toothed workpiece, wherein the at least one base ring 2 is manufactured with or from at least one metal, preferably with or from at least two or at least three or more metals.

FIG. 2 shows a method with the following, preferably chronological, method steps:
providing 8 the at least one base ring 2, wherein the at least one base ring 2 comprises or consists of at least one metal, preferably at least two or at least three or more metals, wherein a toothing 4 is arranged on an inner cylindrical surface 5 of the at least one base ring 2 and can be brought into contact with the toothed workpiece,
providing 15 at least one mounting ring 6, wherein the at least one mounting ring 6 comprises or consists of at least one synthetic resin,
providing 16 at least one support ring 7 by connecting the at least one base ring 2 with the at least one mounting ring 6, preferably wherein the at least one base ring 2 is surrounded in a radial direction by the at least one mounting ring 6,
providing 9 the at least one abrasive 3,
coating 10, preferably galvanic coating, the toothing 4 of the at least one base ring 2 with the at least one abrasive 3, and/or
coating 17, preferably galvanic coating, the at least one support ring 7, preferably the toothing 4 of the at least one base ring 2 of the at least one support ring 7 with the at least one abrasive 3.

As shown in FIG. 2, it may be provided that the provision 8 of the at least one base ring 2 comprises at least one, preferably two, three, four or more of the following, preferably chronological, method steps:
pressing 11, preferably hot pressing and/or cold welding, of the at least one base ring 2 made of metal powder,
sintering 11 of the at least one base ring 2 made of metal powder,
machining 11 of the at least one base ring 2 from solid metal material,
machining 12, preferably turning of the outer diameter, the inner diameter and/or at least one of the two end faces, of the at least one base ring 2,
providing 13 a pre-toothing on the at least one base ring 2, preferably using a profile grinding wheel,
dressing 14 the at least one base ring 2, preferably with a dressing wheel, in particular preferably with a diamond coating.

As partially shown in FIG. 2, it may be provided that the provision of the at least one mounting ring 6 and/or support ring 7 comprises at least one, two, three, or all of the following, preferably chronological, method steps:
arranging, preferably centering, the at least one base ring 2 in a casting mold
casting around the at least one base ring 2 in a radial direction with a synthetic resin compound,
curing of the synthetic resin compound to form at least one mounting ring 6,
machining 18, preferably turning of the outer diameter, the inner diameter and/or at least one of the two end faces, of the at least one mounting ring 6 and/or of the at least one support ring 7.

A method for manufacturing a honing ring 1 for surface finishing of a toothed workpiece, preferably a gear, can comprise all method steps as in the exemplary embodiment shown in FIG. 2. This exemplary embodiment should not be understood as limiting. All method steps disclosed here can be combined, swapped, repeated, and arranged differently chronologically within the method.

The exemplary embodiment of the method shown in FIG. 3 can be carried out practically as follows:

A mixture of aluminum powder with a purity of 99% and fine dendritic copper powder with a purity of 99.9% is provided. The composition of this could be, for example, 6% aluminum and 94% copper.

Hot pressing compresses the mixture of the two metal powders into a porous, solid and stable base ring. The strength of the formed base ring is based solely on the interlocking of the powder particles, which are compressed above the yield point and interlocked. Technically, the process is a cold welding.

All ductile metal powders and/or metal alloy powders can be used to manufacture such solid and stable base rings, for example copper powder, copper-aluminum powder, bronze powder and/or brass powder.

This results in a very large variety of controllable physical properties of the solid and stable base ring, such as density, electrical conductivity, thermal conductivity, heat capacity and/or temperature conductivity.

Depending on the composition, a density between 2.7 g/cm³ and 8.6 g/cm³ can be set. The density of the solid and stable base ring with the above exemplary composition can be 6.6 g/cm³.

Furthermore, mechanical properties such as toughness and/or strength can be controlled via the particle shape, particle size and distribution of the metal powders and/or alloy powders and/or process parameters such as compression pressure, temperature and/or time.

Sintering temperatures are reached at higher processing temperatures than in hot pressing. Thus, the powders can be sintered into stable base rings. This involves an atomic exchange between the touching surfaces of the metal particles. In other words, this is a diffusion of metal atoms due to a difference in the electrochemical potential of the metal particles.

After the base ring has been manufactured, a pre-toothing can be machined onto the inner cylindrical surface using a profile grinding wheel, the toothing can be finished using a dressing wheel, and then the toothing can be coated with at least one abrasive, preferably galvanically.

Additionally, a mounting ring can be manufactured before the coating or even before the machining of the gear teeth and/or pre-toothing. For this purpose, the base ring can be cast around with a synthetic resin compound, which then hardens and is thus bonded to the base ring. The synthetic resin may comprise a resin, a hardener and optional fillers.

The synthetic resin can comprise, for example, as a resin the SG 140 L whitish component A from ebalta Kunststoffe GmbH, as hardener the PUR 12 brown transparent component B from ebalta Kunststoffe GmbH and as filler, the filler F-A, F-B, F-G, F-Alu and/or MF-Paste from ebalta Kunststoffe GmbH.

Although the preceding description has been provided with a certain degree of detail, it should be noted that many changes can be made to the details of the construction of the exemplary embodiments and the arrangement of their components without deviating from the basic concept and scope of this disclosure. It is understood that the invention is not limited to the embodiments presented here for illustrative purposes.

All described exemplary embodiments of the honing ring and of the method can, if technically possible, be combined with each other and/or supplemented by individual features of other exemplary embodiments.

1. A honing ring for surface finishing a toothed workpiece, preferably a gear, comprising:
at least one base ring,
at least one abrasive, and
a toothing arranged on an inner cylindrical surface of the at least one base ring,
wherein the toothing of the at least one base ring is at least partially, preferably completely, coated with the at least one abrasive, preferably galvanically, and can be brought into contact with the toothed workpiece, and
wherein the at least one base ring comprises or consists at least in regions of at least one metal, preferably at least two or at least three or more metals.

2. The honing ring according to claim 1, wherein the at least one metal is a non-ferrous metal.

3. The honing ring according to claim 1, wherein the at least one metal has an electrical conductivity greater than 1.00·10⁷ S/m, preferably greater than 1.30·10⁷ S/m, particularly preferably greater than 3.00·10⁷ S/m.

4. The honing ring according to claim 1, wherein the at least one metal is aluminum, copper, zinc, or tin, and/or the at least one base ring comprises or consists of at least one alloy, wherein the at least one alloy is bronze, in particular aluminum bronze, or brass.

5. The honing ring according to claim 1, wherein the at least one abrasive has or consists of abrasive grains, preferably wherein the abrasive grains have a grain size between 0.035 mm and 0.181 mm, particularly preferably between 0.039 mm and 0.091 mm, most preferably of 0.054 mm, and/or between 57 mesh and 500 mesh, particularly preferably between 80 mesh and 400 mesh, most preferably between 100 mesh and 139 mesh.

6. The honing ring according to claim 1, wherein the at least one abrasive comprises or consists of diamond and/or boron nitride, preferably cubic boron nitride, abbreviated CBN.

7. The honing ring according to claim 1, wherein the at least one base ring is surrounded in the radial direction by at least one mounting ring, wherein the at least one mounting ring comprises or consists of at least one synthetic resin.

8. The honing ring according to claim 7, wherein the at least one synthetic resin comprises or consists of polyurethane.

9. The honing ring according to claim 7, wherein the at least one synthetic resin is a 2-component synthetic resin.

10. The honing ring according to claim 7, wherein the at least one synthetic resin comprises or consists of at least one resin and at least one hardener.

11. The honing ring according to claim 7, wherein the at least one synthetic resin has fillers, preferably wherein the mass fraction of the fillers in the at least one synthetic resin is between 5% and 65%, particularly preferably between 10% and 50%.

12. An arrangement comprising a honing ring for surface finishing a toothed workpiece, preferably a gear, according to claim 1, and the toothed workpiece and, optionally, a honing machine for clamping the honing ring.

13. A method for manufacturing the honing ring according to claim 1, wherein the honing ring has at least one base ring and at least one abrasive, wherein a toothing is arranged on an inner cylindrical surface of the at least one base ring, wherein the toothing of the at least one base ring is coated, at least in regions, preferably completely, with the at least one abrasive, preferably galvanically, and can be brought into contact with the toothed workpiece, wherein the at least one base ring is manufactured with or from at least one metal, preferably with or from at least two or at least three or more metals.

14. The method according to claim 13, with the following, preferably chronological, method steps:
providing the at least one base ring, wherein the at least one base ring comprises or consists of at least one metal, preferably at least two or at least three or more metals, wherein a toothing is arranged on an inner cylindrical surface of the at least one base ring and can be brought into contact with the toothed workpiece,
providing the at least one abrasive,
coating, preferably galvanically coating, the toothing of the at least one base ring with the at least one abrasive.

15. The method according to claim 13, wherein the provision of the at least one base ring comprises at least one, preferably two, three, four or more of the following, preferably chronological, method steps:
pressing, preferably hot pressing and/or cold welding, the at least one base ring made of metal powder,
sintering the at least one base ring made of metal powder,
machining the at least one base ring from solid metal material,
machining, preferably turning of the outer diameter, the inner diameter and/or at least one of the two end faces, of the at least one base ring,
providing a pre-toothing on the at least one base ring, preferably using a profile grinding wheel,
dressing the at least one base ring, preferably with a dressing wheel, in particular preferably with diamond coating.

16. The method according to claim 13 comprising at least one of the following, preferably chronological, method steps:
providing at least one mounting ring, wherein the at least one mounting ring comprises or consists of at least one synthetic resin,
providing at least one support ring by connecting the at least one base ring with the at least one mounting ring, preferably wherein the at least one base ring is surrounded in a radial direction by the at least one mounting ring,
coating, preferably galvanic coating, the at least one support ring, preferably the toothing of the at least one base ring of the at least one support ring with the at least one abrasive.

17. The method according to claim 13, wherein the provision of the at least one mounting ring and/or of the support ring comprises at least one, two, three or all of the following, preferably chronological, method steps:
arranging, preferably centering, the at least one base ring in a casting mold
casting around the at least one base ring in a radial direction with a synthetic resin compound,
curing of the resin compound to form at least one mounting ring,
machining, preferably turning of the outer diameter, the inner diameter and/or at least one of the two end faces, of the at least one mounting ring and/or of the at least one support ring.

18. The method according to claim 13, wherein the at least one metal and/or the metal powder and/or the solid metal material comprises or consists of at least one dendritic metal, aluminum, copper, preferably dendritic copper, zinc, tin, bronze, preferably aluminum bronze, and/or brass.

19. A method for surface finishing of toothed workpieces using the honing ring according to claim 1, the method comprising the following, preferably chronological, method steps:
clamping the honing ring in a honing machine,
processing a toothed workpiece, preferably a gear, particularly preferably a transmission gear, with the honing ring clamped in the honing machine.
